(19) United States
(12) Patent Application Publication
(10) Pub. No.: US 2009/0106810 A1
(43) Pub. Date: Apr. 23, 2009

(54) Ultra wideband communications protocols

(75) Inventors: William Stoye, Cambridge (GB); Julian Hall, Cambridge (GB)

Correspondence Address: VAN PELT, YI & JAMES LLP, 10050 N. FOOTHILL BLVD #200, CUPERTINO, CA, 95014, US

(73) Assignee: Artimi, Inc., Santa Clara, CA (US)

(21) Appl. No.: 11/976,204

(22) Filed: Oct. 22, 2007

(51) Int. Cl. H04B 1/40

(52) U.S. Cl. 725/131

(57) ABSTRACT

A distributed reservation protocol for medium access control in a multiband OFDM ultrawideband communications network having a band group comprising a plurality of transmission bands, a device in said network having a mode in which it uses a selected one of said bands to communicate, and a band hopping mode, and wherein the protocol comprises allowing a device in a group of devices to make a combined time-frequency reservation, said time-frequency reservation comprising a reservation of a combination of a subset of said bands in a said band group and one or more data communications timeslots in which the device is allowed to use said reserved band for data communications such that multiple said devices in said group are able simultaneously to use one or more of the same or overlapping said reserved timeslots in different reserved frequency bands of said band group.

### FIELD OF THE INVENTION

The invention relates to a distributed reservation protocol for a MultiBand Orthogonal Frequency Division Modulation (MB-OFDM) ultra wideband (UWB) communications system, and to processor control code and devices configured to implement the protocol, and to signals within the system.

### BACKGROUND TO THE INVENTION

The MultiBand OFDM Alliance (MBOA), more particularly the WiMedia Alliance, has published a standard for a UWB physical layer (PHY) for a wireless personal area network (PAN) supporting data rates of up to 480 Mbps (“MultiBand OFDM Physical Layer Specification”, release 1.1, Jul. 14, 2005; release 1.2 is now also available). The WiMedia Alliance has also published standard for a UWB Medium Access Control (MAC) layer, “Distributed Medium Access Control (MAC) for Wireless Networks”, release 1.01, Dec. 15, 2006. The skilled person in the field will be familiar with the contents of these documents, which are not reproduced here for conciseness. However, reference may be made to these documents to assist in understanding embodiments of the invention. Further background material may be found in Standards ECMA-368 and ECMA-369.

Broadly speaking a number of band groups are defined, for example one at around 3 GHz and a second at around 6 GHz, in Europe and the USA each comprising three 528 MHz bands (in Japan the 6 GHz use of the band group is more restricted). FIG. 1a, which is taken from ECMA-368, shows the band group allocation (band group 2 is effectively unavailable because it overlaps with WiFi (Registered Trade Mark)). The OFDM scheme employs 110 sub-carriers including 100 data carriers which, at the fastest encoded rate, carry 200 bits using DCM (dual carrier modulation). A ¾ rate Viterbi code results in a maximum data under the current version of this specification of 480 Mbps. Reduced signal strength, interference and like can reduce this data rate down to a specified minimum rate of 53 Mbps. The OFDM symbols are transmitted at 3.2 MHz, that is about 3 per microsecond.

As defined in the standard a device in the system has two modes of operation: a FFI (Fixed Frequency Interleaving) mode where coded information is transmitted on a single band, and a frequency hopping mode of operation, referred to as TFI (Time-Frequency Interleaving). In TFI over about a microsecond the device hops in sequence between the three frequency bands in order to reduce the transmit power in any particular band, hence effectively allowing an increase of 4.7 dB in transmit power. The drawback is that more bandwidth is used for the same 480 Mbps raw data rate.

ECMA-368 defines a MAC standard including a distributed protocol for access and allocation of addresses. There is no central control node and instead a distributed reservation protocol (DRP) is employed, broadly a device observing which resources are used by other devices and then making a choice of address and channel time; a conflict resolution protocol is also provided. Frequency reuse is employed and each device beacons to its neighbour, mainly for the purposes of the MAC, inter alia to maintain synchronisation. A variable length beacon period is divided into 85 μs beacon slots and a device beacon provides information about the neighbours of a device (other devices it can “hear”—receive from) and therefore a received beacon can provide a device with information relating to its neighbour's neighbours including, in particular the occupancy of beacon slots. Broadly a device is able to transmit in a slot if it appears free and it also perceived as free by the device's neighbours' this enables spatial reuse of frequencies.

Communications in the MAC layer are organised into superframes, each superframe comprising 256 medium access slots each of 256 μs (a total of 65 ms). A device may use one or more MAS slots depending upon the requirements of a communication channel between devices. FIG. 1b, which is taken from ECMA-368, shows the MAC superframe structure and FIG. 1c shows details of a beacon period (BP).

FIG. 1d shows the general format of an example MAC frame for a beacon including from 1 to N information elements (IEs) for BPO (Beacon Period Occupancy) and DRP (Distributed Reservation Protocol) data, as well as other information elements. The MAC header comprises, in addition to control information and information identifying the type of frame (0 for a beacon frame), a source and destination address each specified by a 16 bit device address (DevAddr) which is generated locally by a device, essentially randomly avoiding addresses known to be used by neighbours and neighbour's neighbours. Most (but not all) devices also have a globally unique 48 bit extended unique identifier (EUI-48™) and provision is also made for including this value in a beacon. Device address clashes can be identified either by one device noting that another is using its own address as a source address, or by receiving similar information from a neighbour about its neighbours, that is that a neighbour's neighbour is using the device's own address as a source address.

The BPO information element (BPOIE) provides information on the beacon period (see FIG. 1c) as observed by the device sending the BPOIE. The BPOIE includes a bit map of occupied beacon slots, formatted as a variable length array with each element corresponding to a beacon slot and the DevAddrs corresponding to the beacon slots encoded as occupied in the beacon slot information bit map (in sending beacon slot order). Beacon slots 0 and 1 are signalling slots used for a device to advertise when a slot is used, since the length of the beacon period (in terms of number of slots) is variable, for power saving, and thus devices extend their view of the beacon period as necessary.

As mentioned above, different applications have different requirements in terms of throughput and maximum delay (latency), and this translates into a repetition rate of an allocated time slot within a single superframe having a slot duration of n MAS periods, repeated in subsequent superframes. The pattern of MASs depends upon the type and priority of data—for example real time delay data requires a low latency whereas for bulk data transmission the delay is of little consequence but a large channel time is desirable.

The MAC co-ordinates access within a superframe. The DRP protocol enables an initiating device (“owner”) to make a claim for channel time between the owner and another device (“target”). Broadly the owner device decides on the request and inserts a DRP information element in its outgoing beacon claiming some MASs which it believes are free DRP lEs in the beacons from other devices. Thus the owner sends a DRP and qualifies the target with a target address (DevAddr). The target device is responsible for granting the request and for providing ongoing reconfirmation during the period of use that the channel time requested by the owner remains free.

Details of a DRP reservation request and response can be found in ECMA-368 sections 16.5.1 and 16.5.2 (hereby incorporated by reference) and details of the DRP IE can be found in ECMA-368 sections 16.8.6 and 16.8.7 (also hereby incorporated by reference). Details of the DRP IE are shown in FIG. 1e (upper); details of the “DRP Control” field in the DRP IE are shown in FIG. 1e (lower), both taken from ECMA-368; the DRP IE is used to negotiate a reservation of MASs and to announce reserved MASs. In the DRP Control field the reservation status bit indicates the status of the negotiation process (zero=under negotiation/conflict; set to one by a device granting or maintaining a reservation). The owner bit indicates if the device transmitting the DRP IE is the reservation owner; the conflict tie-breaker bit is set to a random value when a reservation request is made; the Unsafe bit indicates when any of the MASs identified in the DRP Allocation fields is considered in excess of reservation limits (the reservation is unsafe because part of the reservation may be seized by another device).

As explained in ECMA-368 section 16.8.6, the DRP IE contains one or more DRP Allocation fields each encoded using a zone structure: The superframe is split into 16 zones numbered 0-15 starting from the BPST (Beacon Period Start Time), each zone containing 16 MAS slots, numbered 0-15, consecutive in time within the zone. The beacon period occupies at least MAS 0; it may also occupy MAS 1, 2 and so forth, depending on how many devices are nearby. The DRP Allocation field contains a zone bitmap field which identifies zones which contain reserved MASs and a MAS bitmap which identifies which MASs in the identified zones are part of the reservation. Thus a reservation cannot be an arbitrary shape: it is defined by a 16-bit zone bitmap and a 16-bit MAS bitmap within the zone.

In more detail, from the specification: “the Zone Bitmap field identifies the zones that contain reserved MASs. If a bit in the field is set to one, the corresponding zone contains reserved MASs, where bit zero corresponds to zone zero. The MAS Bitmap specifies which MASs in the zones identified by the Zone Bitmap field are part of the reset a bit in the field one, the corresponding MAS within each zone identified by the Zone Bitmap is included in the reservation, where bit zero corresponds to MAS zero within the zone.” This facilitates meeting a latency requirement (ie a regular spacing in time), or obtaining a large contiguous block (more efficient), or some mix of the two.

As explained in Appendix B2 of ECMA-368 (also hereby incorporated by reference) a reservation has a row component and a column component. The row component comprises a portion of a reservation that includes an equal number of MASs at the same offset(s) within every zone, optionally excluding zone zero, as indicated in the DRP Ies; the column component comprises the portion of the reservation that is not a row component. A superframe may thus conveniently be represented as a 2D array of 16×16 MAS slots (256 μs×256 μs, 65 ms in total) in which each column comprises 16 adjacent-in-time MASs, as shown in FIG. 1f. This figure also illustrates two example reservations.

Hitherto, the MAC has operated entirely within the time domain, in either a single-band or a hoping mode. However there is a continuing need for improvements to MB OFDM UWB communications systems.

### SUMMARY OF THE INVENTION

According to the present invention there is therefore provided a distributed reservation protocol (DRP) for medium access control (MAC) in a multi-band (MB) orthogonal frequency division modulation (OFDM) ultra wideband (UWB) communications network, said multi-band orthogonal frequency division modulation ultra wideband communications system having a communications band group comprising a plurality of transmission bands, a group of devices in data communications range of one another within said communications network having a communications mode in which the device uses a selected one of said bands to communicate and a band hopping communications mode in which the device hops amongst said plurality of bands whilst communicating, and wherein the protocol comprises allowing a said device in said group to make a combined time-frequency reservation, said time-frequency reservation comprising a reservation of a combination of a subset of said bands in a said band group and one or more data communications timeslots in which the device is allowed to use said reserved band for data communications such that multiple said devices in said group are able simultaneously to use one or more of the same or overlapping said reserved timeslots in different reserved frequency bands of said band group.

The inventors have recognised that the MAC may be extended into the frequency domain to enable a device to specifically reserve a subset of bands within a band group, in embodiments a single said band. In this way, by extending the MAC multiple devices within a communications network may reserve different bands for simultaneous communication which, under certain circumstances, can be advantageous, albeit that a larger MAS occupancy table is required since this is now three-dimensional, including bands, rather than two-dimensional as described in the introduction.

The technique is advantageous in particular where there are multiple concurrent transfers within a beacon group of devices, each within such close range that were they to operate in TFI mode they would be able to run at 480 Mbps with some dB of sensitivity to spare (because use of a single band effectively requires 4.7 dB less transmit power).

In embodiments of the protocol a device stores a map of a time-frequency reservation with one or two time dimensions specifying reserve timeslots within a superframe and a frequency dimension for specifying reserved bands within a band group. Thus in embodiments the map is a 3D map with row and column time dimensions and a third, frequency dimension specifying the bands of a band group; this may be viewed as a map comprising a number of different planes, each plane specifying MAS time slot reservations for a specific frequency band group.

In embodiments the MAC of a device is able to select between a mode of operation in which a subset of the bands in a band group, preferably a single selected band, specified by the time-frequency reservation is used, and a mode of operation in which band hopping (TFI) communications are used. A selection of the operating mode maybe made in response to the RSSI (received signal strength indication) for example of a beacon signal or in response to a link quality indicator (LQI) value, both of which broadly correspond to a measure of a signal-to-noise ratio. Alternatively a PER (packet error rate) in previous packets maybe employed to selected between operating modes, although this is less preferable because of the latency involved in processing the packets to determine the PER and also because with this approach it is difficult to determine whether the system is on the border line of acceptability or has some signal strength in hand.

Since the MAC covers multiple bands within a band group it embodiments there is only a single instance of the MAC within a band group and thus preferably, to avoid interference between beacons, each device transmits it beacon message on a single, common channel, preferably a TFI channel as this as this provides the best coverage.

In general the above protocol comprises a method implemented on a UWB device within the communications network, for example in software, and more specifically real-time firmware.

Thus the invention also provides processor control code to implement the above-described protocols and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention preferably comprises code for a hardware description language such as Verilog (Trade Mark) or VHDL (Very high speed integrated circuit Hardware Description Language) or SystemC, although it may also comprise source, object or executable code in a conventional programming language (interpreted or compiled) such as C, or assembly code, or code for setting up or controlling an ASIC (Application Specific Integrated Circuit) or FPGA (Field Programmable Gate Array). As the skilled person will appreciate such code and/or data may be distributed between a plurality of coupled components in communication with one another.

Similarly in a related aspect the invention provides a multi-band orthogonal frequency division modulation ultra wideband communications device having a medium access control (MAC) system configured to implement a distributed reservation protocol (DRP) for medium access control in a multi-band orthogonal frequency division modulation ultra wideband communications network, said multi-band orthogonal frequency division modulation ultra wideband communications network having a communications band group comprising a plurality of transmission bands, said device having a communications mode in which the device uses a selected one of said bands to communicate and a band hopping communications mode in which the device hops amongst said plurality of bands whilst communicating, and wherein said medium access control system further comprises a system to allow the device to make a combined time-frequency reservation, said time-frequency reservation comprising a reservation of a combination of a subset of said bands in a said band group and one or more data communications timeslots in which the device is allowed to use said reserved band for data communications such that multiple said devices in a group of said devices in data communications range of one another are able simultaneously to use one or more of the same said reserved timeslots in different reserved frequency bands of said band group.

The invention also provides a multi-band orthogonal frequency division modulation ultra wideband communications network, said multi-band orthogonal frequency division modulation ultra wideband communications network having a communications band group comprising a plurality of transmission bands, said multi-band orthogonal frequency division modulation ultra wideband communications network comprising a group of multi-band orthogonal frequency division modulation ultra wideband communications devices in data communications range of one another, each said device having a medium access control (MAC) system configured to implement a distributed reservation protocol (DRP) allowing a said device in said group to make a combined time-frequency reservation, said time-frequency reservation comprising a reservation of a combination of a subset of said bands in a said band group and a data communications timeslot in which the device is allowed to use said reserved band for data communications, and wherein said distributed reservation protocol is further configured to enable simultaneously a first of said transmissions bands to be allocated to data communications between a first pair of devices in said group and a second of said transmission bands to be allocated to data communications between a second pair of devices in said group different to said first pair of devices.

The invention further provides a beacon signal for a multi-band orthogonal frequency division modulation ultra wideband communications network as described above, the beacon signal including distributed reservation protocol data specifying a desired or actual multi-band time-frequency reservation, said time-frequency reservation comprising a reservation of a combination of a subset of said bands in a said band group and one or more data communications timeslots in which the device is allowed to use said reserved band for data communications such that multiple said devices in said group are able simultaneously to use one or more of the same or overlapping said reserved timeslots in different reserved frequency bands of said band group.

The invention still further provides data memory storing a map of a time-frequency reservation for an multi-band orthogonal frequency division modulation ultra wideband communications network as described above, said map having one or two time dimensions specifying reserved timeslots within a superframe comprising a plurality of medium access slots (MASs) and a frequency dimension specifying reserved bands within said communications network.

### BRIEF DESCRIPTION OF THE DRAWINGS

These and other aspects of the invention will now be further described, by way of example only, with reference to the accompanying figures in which:

FIGS. 1a to 12f show, respectively, band group and band allocation in MB-OFDM UWB, a MAC superframe structure, details of a beacon period (BP), a general format of an example MAC frame for a beacon including beacon period occupancy (BPO) and distributed reservation protocol (DRP) data, a DRP IE and details of the DRP Control field, and a superframe represented as a 2D array of MAS slots;

FIGS. 2a to 2c show, respectively, a three-dimensional MAS occupancy table according to an embodiment of an aspect of the invention, a flow diagram of a procedure for implementing a DRP protocol according to an embodiment of the invention, and an example of a simple UWB communications network with a corresponding example 3D MAS occupancy table;

FIG. 3 shows a MAC system for implementing the procedure of FIG. 2;

FIG. 4 shows a block diagram of a digital OFDM UWB transmitter sub-system

FIG. 5 shows a block diagram of a digital OFDM UWB receiver sub-system; and

FIGS. 6a and 6b show, respectively, a block diagram of a PHY hardware implementation for an OFDM UWB transceiver and an example RF front end for the receiver of FIG. 6a.

### DETAILED DESCRIPTION OF PREFERRED EMBODIMENTS

The co-location of beacon groups operating on different TFI channels or on a TFI and FFI channel has interference problems. The inventors have recognised that that these can be addressed with an extension to the DRP protocol to enable the reservation of single, or potentially multiple bands within a band group. Extending the view of MAS allocation to three dimensions, that is extending the row/column view of the super frame, enables different reservations to operate using different time-frequency channels.

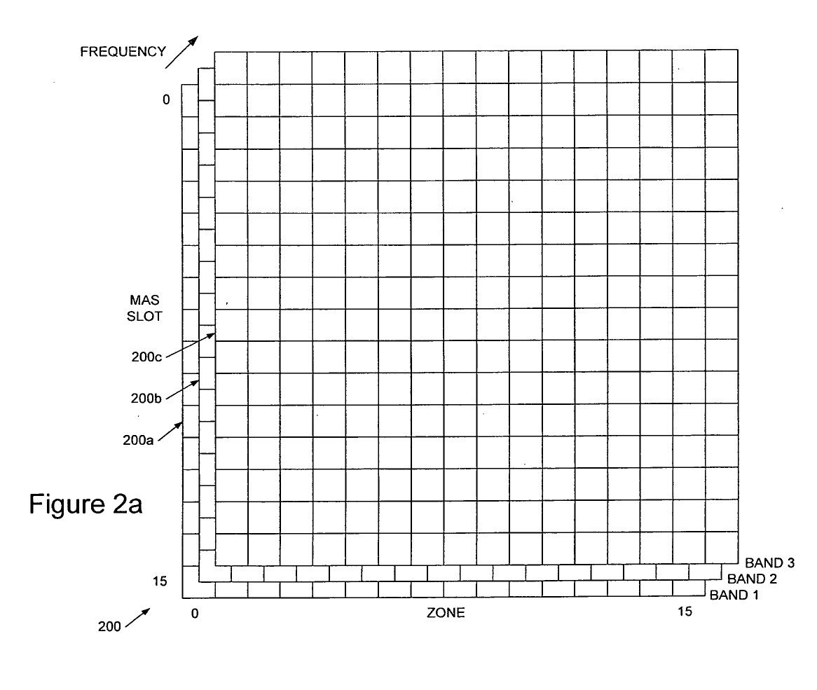

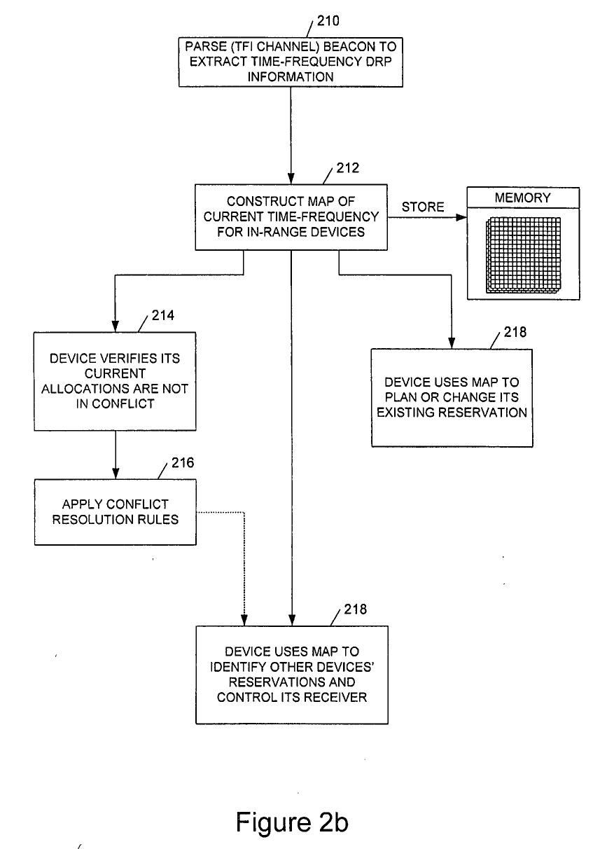

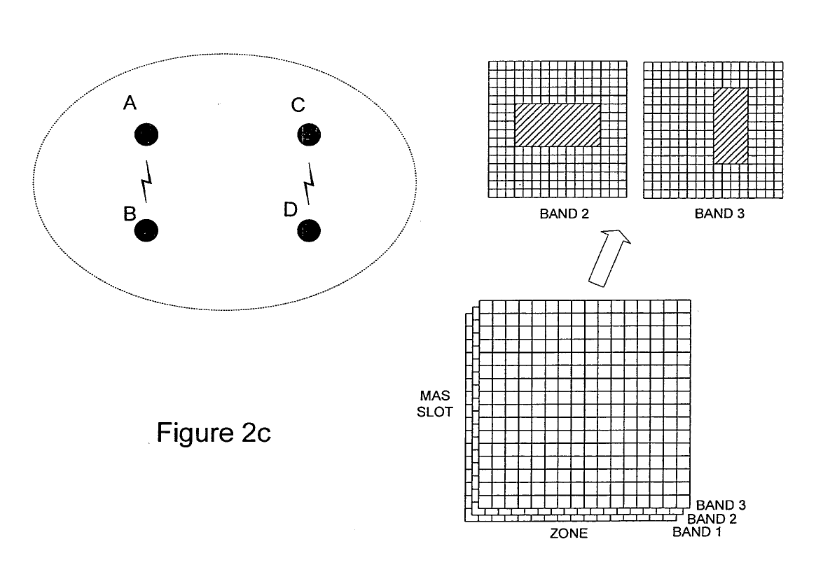

Referring to FIG. 2a, this shows an example of a three dimensional time-frequency occupancy map 200 according to an embodiment of the invention. In this map each plane 200a-c corresponds to a single band of a band group and the MAC is configured to enable a device to reserve a region specified not only by MAS and zone, but also by band. In effect, therefore, a reservation comprises one or more 2D regions in one or more 2D planes of the 3D map.

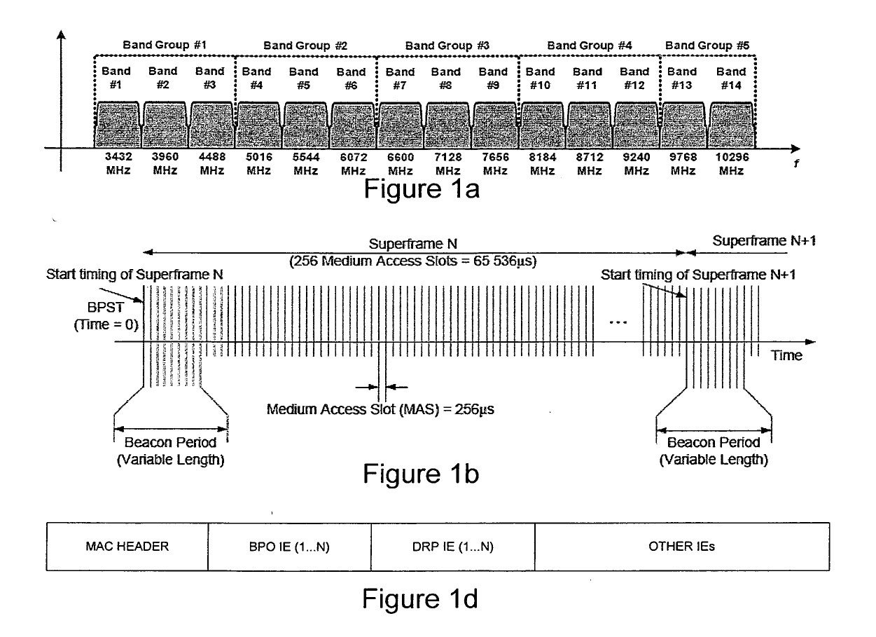

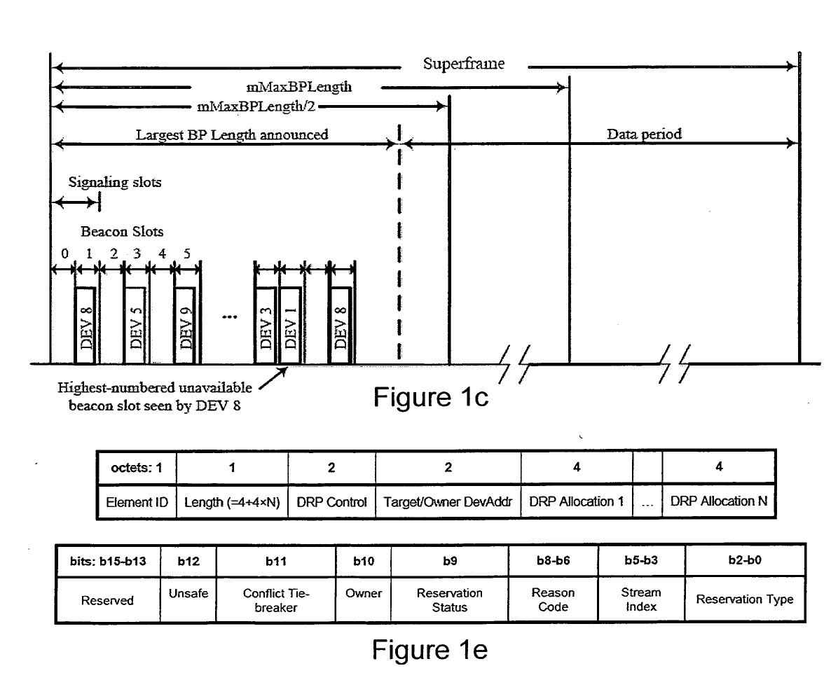

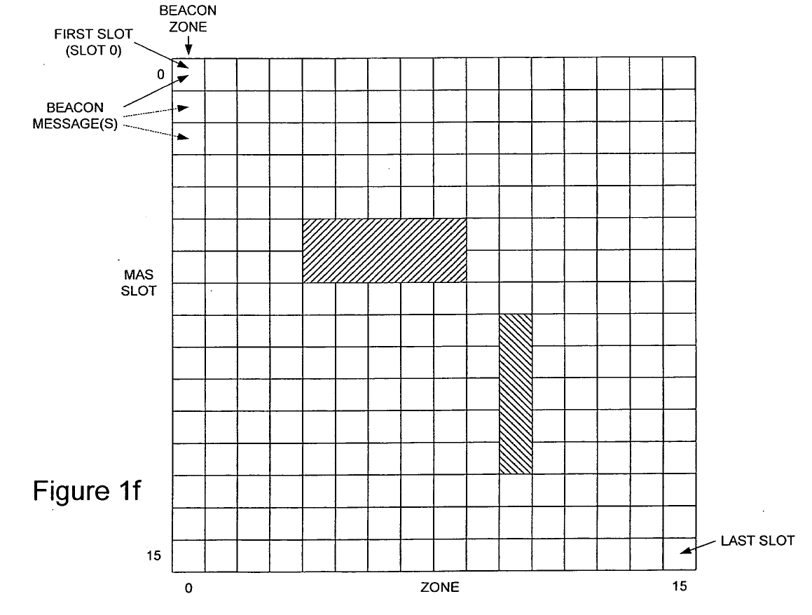

In embodiments of the technique reservations are negotiated using an extension of the DRP protocol in the ECMA-368, for example using the three reserved bits (b15-b13) of the DRP Control field shown in FIG. 1e to specify an intended time-frequency channel by specifying one (or more) intended bands. The concepts of efficient and fair sharing of bandwidth are extended by extending the following techniques: (1) location rules of 2D/3D rows and columns that reduce fragmentation (for example mandating that rows are located in the highest position possible and columns in the lowest); (2) conflict resolution (for example by establishing a common view as to who wins and who loses when there is a reservation conflict); (3) defining unsafe reservations where a portion of a reservation that exceeds a certain limit is viewed as unsafe (and may therefore be claimed by other devices using a Relinquish Request IE). More particularly the conflict rules are extended to cover the co-existence properties of different time-frequency combinations, essentially defining a conflict whenever two devices wish to use the same band at the same time. Optionally two TFI reservations may also be defined to be in conflict (although theoretically there is a possibility of employing statistical techniques to communicate data provided the hops do not completely overlap). Further optionally if some time-frequency combinations are found in practice to work better than others (say, by monitoring their performance) this information maybe incorporated as a preference in favour of “good” combinations or against “bad” combinations of row/column/band selection rules.

In preferred embodiments of the protocol a device negotiates a reservation using a TFI channel, provided sufficient channel time exists. In embodiments of the protocol operating on a TFI channel is defined as unsafe, in that another device my request that this be relinquished to a time-frequency reservation according to the embodiment of the invention.

Referring now to FIG. 2b, this shows a flow diagram of a procedure which maybe implemented in MAC firmware of a device to provide a real time DRP according to an embodiment of the invention.

Referring FIG. 2b, in step 210 a beacon message is received and parsed to extract time-frequency DRP information, for example of the general type shown in FIG. 1e with additional band reservation data in bits 13-15. Then, at step 212, the procedure constructs a map of current time-frequency occupancy for in-range devices, the map comprising for example a 3D occupancy table of the type shown in FIG. 2a. (The skilled person will appreciate that if any in-range device uses TFI then there is no value to attempting a 3D time-frequency reservation and the above described co-existence rules preferably therefore flag such a situation as a conflict.) At this point the procedure may continue in one or more of different ways. The device may employ the occupancy map to verify that its own current allocations are not in conflict (step 214). If there is a conflict then a conflict resolution procedure is employed (step 216), for example using rules as outlined above. This conflict resolution may or may not result in a device changing its desired or actual reservation. In general the device will also use the occupancy map to identify the reservations of other devices and to control its receiver to receive from the other devices in range accordingly (step 218). Further, the procedure may employ the occupancy map to plan or change an existing reservation of the device.

As the skilled person will understand, in embodiments the existing specification is extended to qualify existing procedures using time-frequency reservation band identification data in conflict/co-existence rules, definition of an unsafe reservation, and so forth.

Referring now to FIG. 2c, this shows an example of a simple MB-OFDM UWB communications network comprising four devices A-D, physically configured so that devices A and B and devices C and D are in relative close proximity to one another compared to the distance between the two pairs of devices. Such a physical device arrangement is commonplace and provides an opportunity for increased bandwidth communications using time/frequency reservation techniques as described above. FIG. 2c shows, schematically, an example of a time/frequency reservation with overlapping time reservations on different single frequency bands enabling, potentially, two 480 Mbps links to run concurrently between device pairs AB and CD in different single bands. The example physical arrangement illustrated in FIG. 2c is helpful because since devices A and B, and C and D are in relative close proximity to one another the effective 4.7 dB transmit power loss has little impact, and moreover the physical separation of the two pairs of devices is helpful in potentially reducing interference in the PHYs of one pair of devices due to transmission in an adjacent band of a band group by the other pair of devices. (Optionally the co-existence rules may be tailored, to where bandwidth allows, a range for pairs of communicating devices to use non-adjacent bands within a band group to reduce potential interference from adjacent channels).

Embodiments of the above-described protocol enable the capacity of FFI to be multiplied by three, but also allow the range of TFI, combined in a single flexible system. The MAC beacon is run in TFI mode and reservations can be made for a MAS slot in just one band, which enables the same MAS slot to be allocated to three different owners simultaneously, each having the slot for one specific band. In its own reservation the device can transmit in FFI in its given band. This enables, in embodiments, a theoretical maximum of three times aggregate bandwidth total in a band group and (different to simply using FFI on three bands) all the devices remain in contact with one another. Further embodiments of the protocol can be implemented in a backwards-compatible manner since the protocol may be arranged such that old devices always receive three-band reservations. The improvement in total bandwidth is at the expense of greater processing power and memory requirements because reservation allocation decisions take into account frequency (band) occupancy and because a larger MAS occupancy table is needed. The protocol is particularly advantageous in UWB communication networks with no single master, as this facilitates different devices having different time/frequency reservations (as illustrated in FIG. 2c).

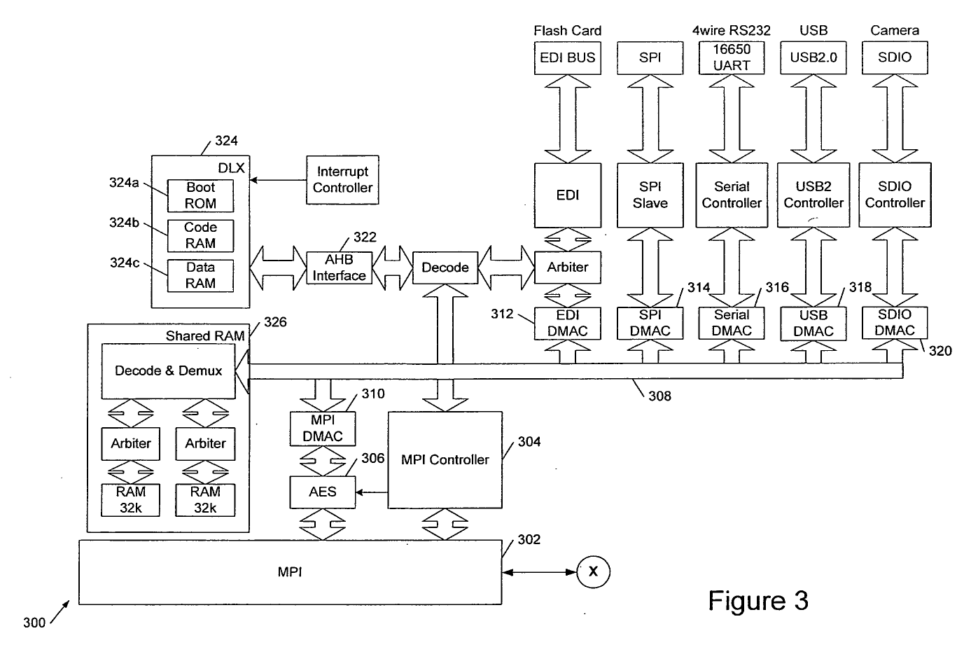

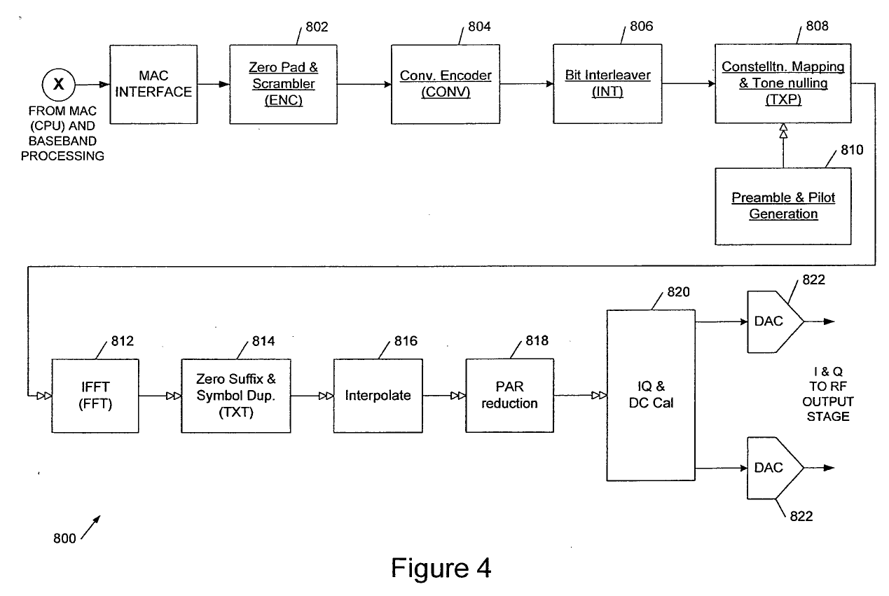

FIG. 3 shows a medium access control (MAC) system 300 for a UWB transceiver (the physical layers of which are described below with reference to FIGS. 4 to 6), the MAC system 300 being configured to implement a distributed reservation protocol according to an embodiment of the invention, as described above.

The MAC system 300 comprises a message parsing interface (MPI) 302 with a bidirectional data and control connection, “X” to the physical layer hardware shown in FIGS. 4 to 6. The MPI 302 is coupled to an MPI controller 304, which also interfaces to AES (Advanced Encryption Standard) hardware 306, which has a separate connection to MPI 302. The MPI controller 304 is coupled to a bi-directional data and control bus 308 to which are coupled a plurality of DMAC (Direct Memory Access Control) units including an MPI DMAC 310, an EDI (Electronic Data Interchange) DMAC 312, an SPI (Serial Peripheral Interface) DMAC 314, a serial DMAC 316, a USB (Universal Serial Bus) DMAC 318 and an SDIO (Secure Digital I/O memory card) DMAC 320. Each of DMACs 312-320 is coupled to a respective controller and then to a corresponding interface. Bus 308 is also coupled to an AHB (Advanced High-Performane Bus) interface 322 which in turn is coupled to memory 324 including non-volatile code and data memory Boot ROM 324a, code memory (RAM) 324b and data memory (RAM) 324c; bus 308 is also coupled to shared memory (RAM) 326.

In embodiments of the MAC system 300 the Boot and/or code memory 324a, b stores implement a time-frequency DRP as described above. A 3D time-frequency reservation map comprising a plurality of layers each corresponding to a 2D time reservation (MAS slot) map as shown in FIG. 1f for a separate respective band of a band group, may be stored in data RAM 324c.

FIGS. 4 to 6 described below show functional and structural block diagrams of an OFDM UWB transceiver for use with the MAC hardware described above.

Thus referring to FIG. 4, this shows a block diagram of a digital transmitter sub-system 800 of an OFDM UWB transceiver. The sub-system in FIG. 4 shows functional elements; in practice hardware, in particular the (I) FFT may be shared between transmitting and receiving portions of a transceiver since the transceiver is not transmitting and receiving at the same time.

Data for transmission from the MAC CPU (central processing unit) is provided to a zero padding and scrambling module 802 followed by a convolution encoder 804 for forward error correction and bit interleaver 806 prior to constellation mapping and tone nulling 808. At this point pilot tones are also inserted and a synchronisation sequence is added by a preamble and pilot generation module 810. An IFFT 812 is then performed followed by zero suffix and symbol duplication 814, interpolation 816 and peak-2-average power ratio (PAR) reduction 818 (with the aim of minimising the transmit power spectral density whilst still providing a reliable link for the transfer of information). The digital output at this stage is then converted to I and Q samples at approximately 1 Gsps in a stage 820 which is also able to perform DC calibration, and then these I and Q samples are converted to the analogue domain by a pair of DACs 822 and passed to the RF output stage.

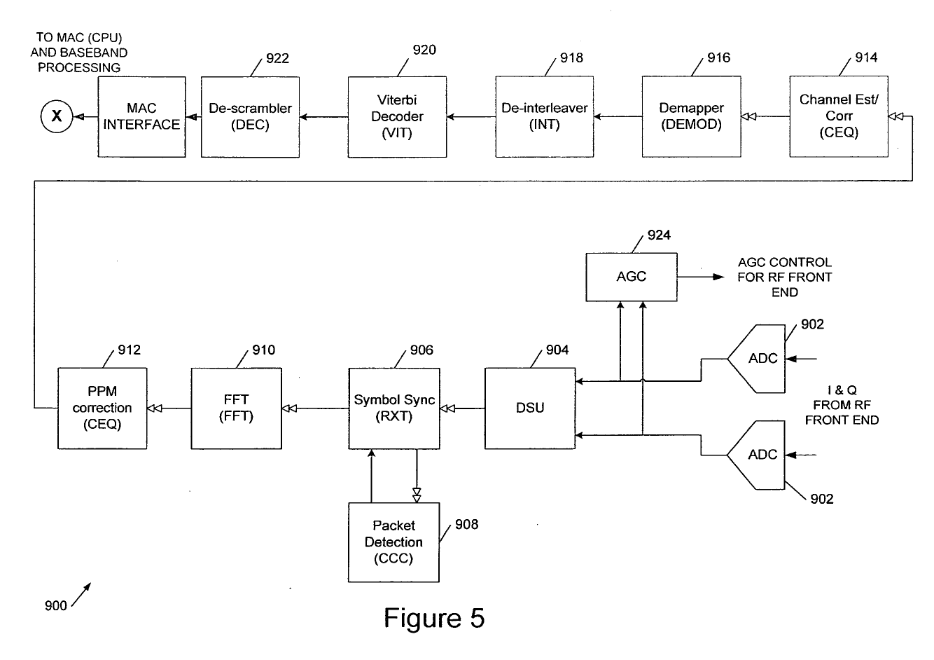

FIG. 5 shows a digital receiver sub-system 900 of a UWB OFDM transceiver. Referring to FIG. 5, analogue I and Q signals from the RF front end are digitised by a pair of ADCs 902 and provided to a down sample unit (DSU) 904. Symbol synchronisation 906 is then performed in conjunction with packet detection/synchronisation 908 using the preamble synchronisation symbols. An FFT 910 then performs a conversion to the frequency domain and ppm (parts per million) clock correction 912 is performed followed by channel estimation and correlation 914. After this the received data is demodulated 916, de-interleaved 918, Viterbi decoded 920, de-scrambled 922 and the recovered data output to the MAC. An AGC (automatic gain control) unit is coupled to the outputs of a ADCs 902 and feeds back to the RF front end for AGC control, also on the control of the MAC.

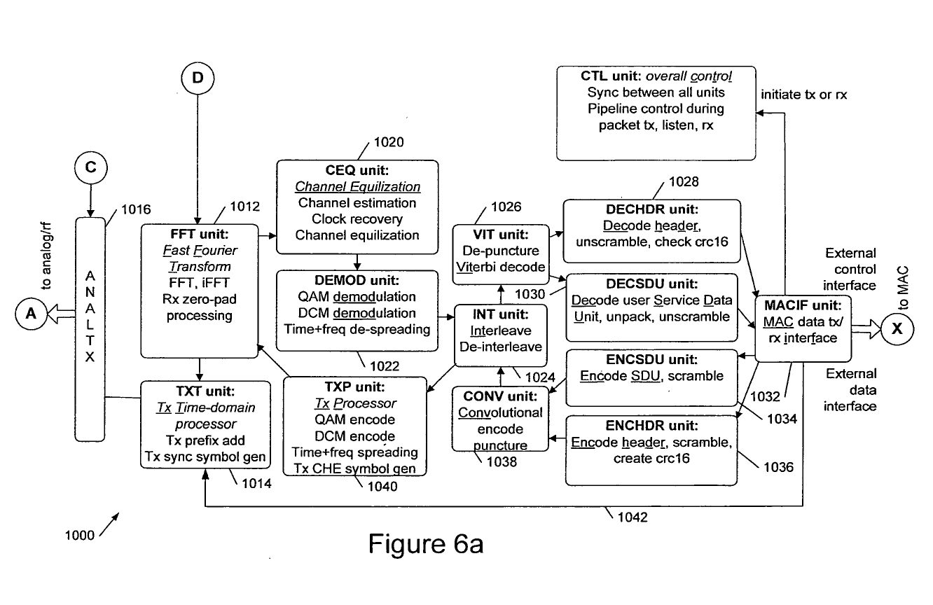

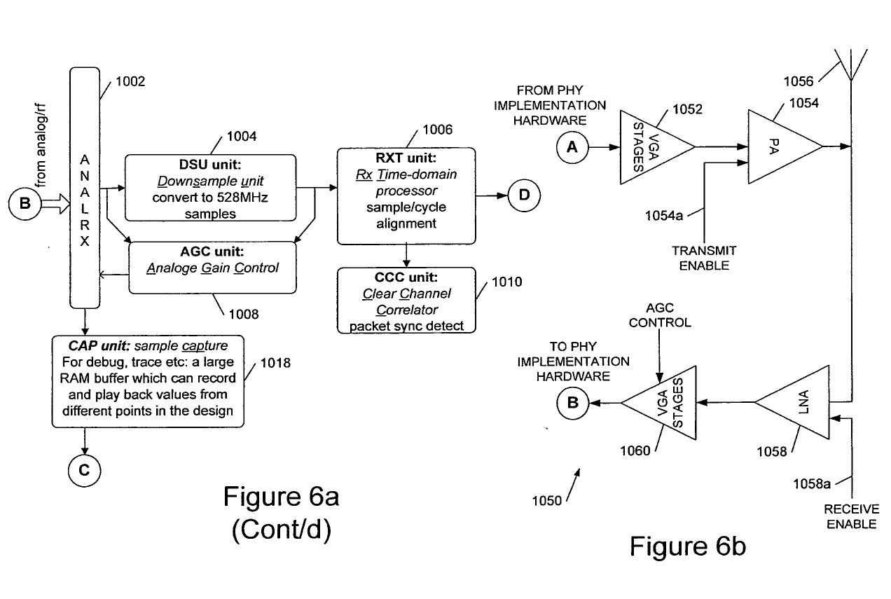

FIG. 6a shows a block diagram of physical hardware modules of a UWB OFDM transceiver 1000 which implements the transmitter and receiver functions depicted in FIGS. 4 and 5. The labels in brackets in the blocks of FIGS. 4 and 5 correspond with those of FIG. 6a, illustrating how the functional units are mapped to physical hardware.

Referring to FIG. 6a an analogue input 1002 provides a digital output to a DSU (down sample unit) 1004 which converts the incoming data at approximately 1 Gsps to 528 Mz samples, and provides an output to an RXT unit (receive time-domain processor) 1006 which performs sample/cycle alignment. An AGC unit 1008 is coupled around the DSU 1004 and to the analogue input 1002. The RXT unit provides an output to a CCC (clear channel correlator) unit 1010 which detects packet synchronisation; RXT unit 1006 also provides an output to an FFT unit 1012 which performs an FFT (when receiving) and IFFT (when transmitting) as well as receiver 0-padding processing. The FFT unit 1012 has an output to a TXT (transmit time-domain processor) unit 1014 which performs prefix addition and synchronisation symbol generation and provides an output to an analogue transmit interface 1016 which provides an analogue output to subsequent RF stages. A CAP (sample capture) unit 1018 is coupled to both the analogue receive interface 1002 and the analogue transmit interface 1016 to facilitate debugging, tracing and the like. Broadly speaking this comprises a large RAM (random access memory) buffer which can record and playback data captured from different points in the design.

The FFT unit 1012 provides an output to a CEQ (channel equalisation unit) 1020 which performs channel estimation, clock recovery, and channel equalisation and provides an output to a DEMOD unit 1022 which performs QAM demodulation, DCM (dual carrier modulation) demodulation, and time and frequency de-spreading, providing an output to an INT (interleave/de-interleave) unit 1024. The INT unit 1024 provides an output to a VIT (Viterbi decode) unit 1026 which also performs de-puncturing of the code, this providing outputs to a header decode (DECHDR) unit 1028 which also unscrambles the received data and performs a CRC 16 check, and to a decode user service data unit (DECSDU) unit 1030, which unpacks and unscrambles the received data. Both DECHDR unit 1028 and DECSDU unit 1030 provide output to a MAC interface (MACIF) unit 1032 which provides a transmit and receive data and control interface for the MAC.

In the transmit path the MACIF unit 1032 provides outputs to an ENCSDU unit 1034 which performs service data unit encoding and scrambling, and to an ENCHDR unit 1036 which performs header encoding and scrambling and also creates CRC 16 data. Both ENCSDU unit 1034 and ENCHDR unit 1036 provide outputs to a convolutional encode (CONV) unit 1038 which also performs puncturing of the encoded data, and this provides an output to the interleave (INT) unit 1024. The INT unit 1024 then provides an output to a transmit processor (TXP) unit 1040 which, in embodiments, performs QAM and DCM encoding, time-frequency spreading, and transmit channel estimation (CHE) symbol generation, providing an output to (I)FFT unit 1012, which in turn provides an output to TXT unit 1014 as previously described.

Referring now to FIG. 6b, this shows, schematically, RF input and output stages 1050 for the transceiver of FIG. 6a. The RF output stages comprise VGA stages 1052 followed by a power amplifier 1054 coupled to antenna 1056. The RF input stages comprise a low noise amplifier 1058, coupled to antenna 1056 and providing an output to further multiple VGA stages 1060 which provide an output to the analogue receive input 1002 of FIG. 6a. The power amplifier 1054 has a transmit enable control 1054a and the LNA 1058 has a receive enable control 1058a; these are controlled to switch rapidly between transmit and receive modes.

Broadly, we have described a device that implements a medium reservation protocol in a wireless local area network to reserve allocations over both time and frequency, in a single integrated reservation system; allowing reservations either over the entire allocation frequency (giving long range), or over bands within it (giving high aggregate bandwidth), or any appropriate mixture. No doubt many other effective alternatives will occur to the skilled person. It will therefore be understood that the invention is not limited to the described embodiments and encompasses modifications apparent to those skilled in the art lying within the spirit and scope of the claims appended hereto.

1. A distributed reservation protocol (DRP) for medium access control (MAC) in a multi-band (MB) orthogonal frequency division modulation (OFDM) ultra wideband (UWB) communications network, said multi-band orthogonal frequency division modulation ultra wideband communications system having a communications band group comprising:
a plurality of transmission bands;
a group of devices in data communications range of one another within said communications network having a communications mode in which the device uses a selected one of said bands to communicate and a band hopping communications mode in which the device hops amongst said plurality of bands whilst communicating; and
wherein the protocol comprises allowing a said device in said group to make a combined time-frequency reservation, said time-frequency reservation comprising a reservation of a combination of a subset of said bands in a said band group and one or more data communications timeslots in which the device is allowed to use said reserved band for data communications such that multiple said devices in said group are able simultaneously to use one or more of the same or overlapping said reserved timeslots in different reserved frequency bands of said band group.

2. A distributed reservation protocol as claimed in claim 1, wherein a said device stores a map of a time-frequency reservation with the communications network, said map having one or two time dimensions specifying reserved timeslots within a superframe comprising a plurality of medium access slots (MASs) and a frequency dimension for specifying reserved bands within said communications network.

3. A distributed reservation protocol as claimed in claim 2, wherein said map is configured as a three-dimensional map with two said time dimensions.

4. A distributed reservation protocol as claimed in claim 1, wherein a medium access control system of a said device is able to select between a mode of operation in which a subset of said bands in a said band group specified by said time-frequency reservation is used and a mode of operation in which said band hopping communications is used.

5. A distributed reservation protocol as claimed in claim, wherein said selection is made responsive to a received signal strength of a beacon signal of said protocol.

6. A distributed reservation protocol as claimed in claim 1, further comprising each said device in said communications network transmitting a beacon on a common channel of said communications network, said common channel being specified by a combination of a specified said band and a beacon timeslot, said beacon comprising data specifying a desired or actual said time-frequency reservation.

7. A distributed reservation protocol as claimed in claim 6, further comprising transmitting said beacon using said band hopping communications mode.

8. A distributed reservation protocol as claimed in claim 1, wherein said subset of said bands in a said band group comprises only a single said band.

9. A carrier carrying processor control code to, when running, implement the distributed reservation protocol of claim 1.

10. A multi-band orthogonal frequency division modulation ultra wideband communications network configured to employ the protocol of claim 1.

11. A multi-band orthogonal frequency division modulation ultra wideband communications device having a medium access control (MAC) system configured to implement a distributed reservation protocol (DRP) for medium access control in a multi-band orthogonal frequency division modulation ultra wideband communications network, said multi-band orthogonal frequency division modulation ultra wideband communications network having a communications band group comprising:
a plurality of transmission bands, said device having a communications mode in which the device uses a selected one of said bands to communicate and a band hopping communications mode in which the device hops amongst said plurality of bands whilst communicating; and
wherein said medium access control system further comprises a system to allow the device to make a combined time-frequency reservation, said time-frequency reservation comprising a reservation of a combination of a subset of said bands in a said band group and one or more data communications timeslots in which the device is allowed to use said reserved band for data communications such that multiple said devices in a group of said devices in data communications range of one another are able simultaneously to use one or more of the same said reserved timeslots in different reserved frequency bands of said band group.

12. A communications device as claimed in claim 11, wherein said subset of said bands in a said band group comprises only a single said band.

13. A multi-band orthogonal frequency division modulation ultra wideband communications network, said multi-band orthogonal frequency division modulation ultra wideband communications network having a communications band group comprising:
a plurality of transmission bands, said multi-band orthogonal frequency division modulation ultra wideband communications network comprising a group of multi-band orthogonal frequency division modulation ultra wideband communications devices in data communications range of one another, each said device having a medium access control (MAC) system configured to implement a distributed reservation protocol (DRP) allowing a said device in said group to make a combined time-frequency reservation, said time-frequency reservation comprising a reservation of a combination of a subset of said bands in a said band group; and
a data communications timeslot in which the device is allowed to use said reserved band for data communications, and wherein said distributed reservation protocol is further configured to enable simultaneously a first of said transmissions bands to be allocated to data communications between a first pair of devices in said group and a second of said transmission bands to be allocated to data communications between a second pair of devices in said group different to said first pair of devices.

14. A communications network as claimed in claim 13, wherein said subset of said bands in a said band group comprises a only single said band.

15. A beacon signal for the multi-band orthogonal frequency division modulation ultra wideband communications network of claim 13, the beacon signal including distributed reservation protocol data specifying a desired or actual multi-band time-frequency reservation, said time-frequency reservation comprising a reservation of a combination of a subset of said bands in a said band group; and
one or more data communications timeslots in which the device is allowed to use said reserved band for data communications such that multiple said devices in said group are able simultaneously to use one or more of the same or overlapping said reserved timeslots in different reserved frequency bands of said band group.

16. A beacon signal as claimed in claim 15, wherein said subset of said bands in a said band group comprises only a single said band.

17. Data memory storing a map of a time-frequency reservation for the multi-band orthogonal frequency division modulation ultra wideband communications network of claim 13, said map having one or two time dimensions specifying reserved timeslots within a superframe comprising a plurality of medium access slots (MASs) and a frequency dimension specifying reserved bands within said communications network.
